(19) United States
(12) Patent Application Publication
(10) Pub. No.: US 2007/0162494 A1
(43) Pub. Date: Jul. 12, 2007

(54) Embedded business process monitoring

(76) Inventor: Thomas Schneider, Heidelberg (DE)

Correspondence Address: FISH & RICHARDSON, P.C., PO BOX 1022, MINNEAPOLIS, MN, 55440-1022, US

(21) Appl. No.: 11/322,874

(22) Filed: Dec. 30, 2005

(51) Int. Cl. G06F 17/00

(52) U.S. Cl. 707/103 R

(57) ABSTRACT

Business processes running on a client system may be modeled by a modeling system. A monitoring system detects modifications made to business objects and business processes running on the client system through the modeling system without manual configuration or reconfiguration.

### TECHNICAL FIELD

The disclosed implementations are related to software monitoring and management.

### BACKGROUND

Today's business processes often depend on automated processing of various applications. In the case of a commercial business, these applications may be used to acquire customers, input orders, ship product, bill customers, collect invoices, pay employees and vendors, order product, audit inventory and maintain records of transactions between employees, customers and suppliers.

These applications use business logic and data that span Web servers, application servers, integration middleware and mainframe systems. While most businesses have traditional monitoring software to manage these complex applications, many lack an integrated solution to automatically monitor, analyze and resolve problems at the service, transaction, application and resource levels, and to immediately respond to detected problems in a timely fashion or to predict problems that may lie ahead.

Furthermore, conventional monitoring software typically employs business process (BP) modeling as a service separate from the business process modeling environment of a client system running the business processes. However, the business process modeling employed by the conventional monitoring software is not bridged to the business process modeling environment utilized by the client. Thus, when technical problems are detected, conventional monitoring software may not always be able to resolve the problems with respect to all aspects of the business process of the client, potentially causing disruption to the client's business.

Moreover, if a particular business process of the client is modified, conventional monitoring software may not automatically detect or adapt to the modification. Consequently, conventional monitoring software may process outdated information, draining time, effort, and expense from other resources, and potentially causing major overhaul to the client's business. Even if the modified business process is timely detected, conventional monitoring software may have to be manually reconfigured to adapt to new settings configured on the client or client's business process model. From an administrative perspective, reconfiguring monitoring software can be time consuming and error prone.

### SUMMARY

The deficiencies of conventional manual software maintenance management solutions are overcome by the disclosed embodiments.

In some implementations, a monitoring system monitors and collects information related to business processes from a client system. The client system may host a business process associated with a business application, where the business process includes a business object and one or more process agents adapted to execute the business process. The client system also may utilize a modeled business process modeled by a modeling system, where the associated business application can be configured to perform the modeled business process. The monitor system may monitor the modeled business process and that associated with the business application for any inconsistency therebetween.

The system can include a client system and a main system, which are operatively coupled to a network. The client system can be any system that uses or deploys software.

In some implementations, the client system may include one or more business applications, and host one or more business processes associated with a particular business application, or functions of an enterprise.

In some implementations, business processes running on the client system may be modeled by a modeling system. In one aspect, the client system may include one or more applications programs containing series of programming instructions that may cause the client system to be configured to perform the business process operations modeled in the modeling system integrated with the client system.

In some implementation, a monitoring system integrated in the main system can monitor business processes simulated by the modeling system to determine if any configurations have been modified. The monitoring system also can monitor the status of a business object, and the status of at least one process agent. The monitoring system also can monitor changes in the configuration of a particular business process, and efficiently provide monitored information associated with real business processes to one or more users of the client system.

In some implementations, a method of monitoring a business process includes: hosting a business process associated with a business application, the business process including a business object and one or more process agents adapted to execute the business process; modeling the business process using a modeled business process, the business application configured to perform the modeled business process; and monitoring configuration data of the modeled business process and that of the business process associated with the business application for any inconsistency therebetween.

In some implementations, a method of monitoring a business process includes: obtaining configuration data associated with an actual business process on a predetermined schedule without user intervention; monitoring a modeled business process simulating the actual business process, the modeled business process having one or more process agents associated with a business object; determining whether the configuration data has been modified based on the modeled business process; and detecting a potential issue associated with the modified configuration data.

In some implementations, a method of monitoring a business process includes: obtaining configuration data associated with an actual business process; monitoring a modeled business process simulating the actual business process on a predetermined schedule without user intervention, the modeled business process having one or more process agents associated with a business object; collecting diagnostic data exchanged between process agents or between at least one of process agents and the business object to detect an event associated with the actual business process; and evaluating whether the detected event is critical.

In some implementations, a method of monitoring a business process includes: hosting an actual business process on a client; modeling the actual business process running on the client; monitoring the modeled business process to detect an event indicating a change in an operational parameter of the actual business process or the modeled business process without user intervention; and automatically routing the event to a service provider if a change is made to the operational parameter of the actual business process or the modeled business process.

Other implementations are disclosed that are directed to systems, computer-readable mediums and apparatuses, including monitoring services with minimal user intervention to detect and prevent potential slowdowns or performance bottlenecks in a computer system, tracking and documenting transactions and messages between business objects, diagnose problems, and generating incident or task events to resolve the documented problems.

### DESCRIPTION OF DRAWINGS

The accompanying drawings, which are incorporated into and form a part of the specification, illustrate several aspects and implementations of the present invention and, together with the general description given above and detailed description given below, serve to explain the principles of the present invention. The drawings are only for the purpose of illustrating preferred implementations of the present invention, and are not to be construed as limiting the present invention. In the drawings:

FIG. 1 is a block diagram of an implementation of a service management system.

FIG. 2 illustrates an exemplary interaction between purchase order processing and sales order processing.

FIG. 3 illustrates exemplary components of a modeling system.

FIG. 4(a) shows exemplary structure of a process component.

FIG. 4(b) shows interaction between two process components.

FIG. 5 is a flow diagram of an exemplary monitoring process.

Like reference numbers and designations in the various drawings indicate like elements.

### DETAILED DESCRIPTION

In the following description, various implementations of the present invention will be described. However, it will be apparent to those skilled in the art that the implementations may be practiced with only some or all aspects of the invention. For purposes of explanation, specific numbers and configurations are set forth in order to provide a thorough understanding of the implementations. However, it will also be apparent to one skilled in the art that the implementations may be practiced without the specific details.

### System Overview

In accordance with one implementation, an embedded services management system is provided. Although this implementation is presented herein in the form of an embedded services management system, it should be understood that the teachings herein may be applied more generally to any management system, including or in addition to management systems involving business processes.

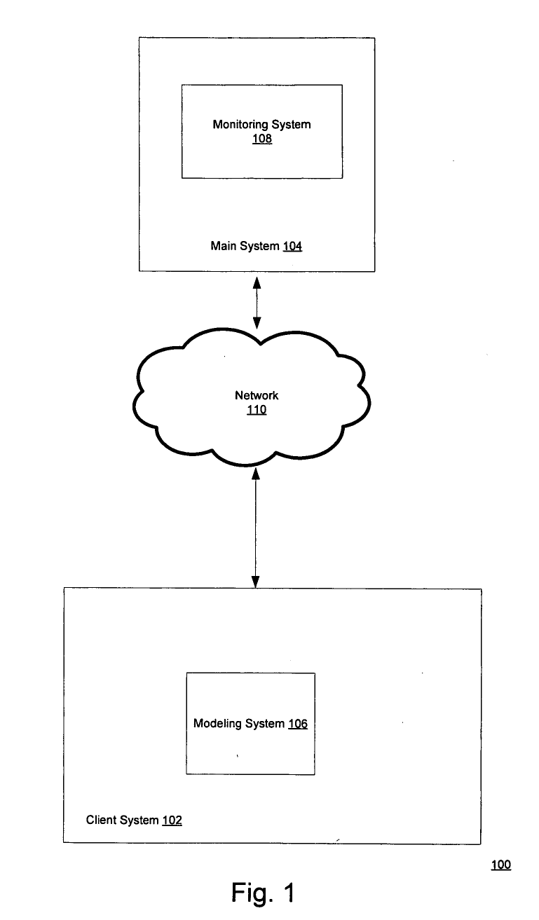

FIG. 1 is a block diagram of an implementation of a service management system 100. The system 100 includes a client system 102 and a main system 104, which are operatively coupled to a network 110 (e.g., Internet, intranet, local area network, Ethernet, wireless network, telephone network, leased telephone or data lines or any combination thereof). The network 110 provides users with transparent, virtual access to applications, processes, and functions regardless of the physical location of the client system 102 where applications, processes, and functions reside.

The client system 102 can be any system that uses or deploys software. The software can be a single application or an operating system, a collection of software applications or software components that perform various tasks in a larger system or application, such as a business application suite (e.g., customer relationship management (CRM), business administration, financial, and manufacturing software). In some implementations, the client system 102 is a runtime environment that runs business processes. The client system 102 may include various servers such as database servers and application servers. The client system 102 may further include one or more business applications, or contain business documents such as sales orders, shipment orders and financial postings. The client system 102 may host one or more business processes associated with a particular business application, or functions of an enterprise.

In some implementations, business processes running on the client system 102 may be modeled by a modeling system 106. In some implementations, the client system 102 may include one or more applications programs containing series of programming instructions that may cause the client system 102 to be configured to perform the business process operations modeled in the modeling system 106 integrated with the client system 102. In other implementations, the modeling system 106 may be separate from the client system 102.

At runtime, a monitoring system 108 integrated with the main system 104 monitors business processes simulated by the modeling system 106 to determine if any configurations have been modified. In some implementations, the monitoring system 108 monitors both the client system 102 and the modeling system 106.

On the client system side, the monitoring system 108 can monitor errors and warnings established during processing of various business objects, particularly those created when a given system processing the business objects has no direct communication with a user (e.g., when the processing of business objects is executed as a background task). In addition, the monitoring system 108 can monitor all types of errors and warnings established during processing of process agents, particularly those created when a given system processing the process agents has no direct communication with a user (e.g., when the user has no access to the system where the process agent(s) is processed because the system belongs to a different organization). The monitoring system 108 also can monitor errors and warnings from underlying infrastructure components, such as application servers, database servers, printers and middleware.

On the modeling system side, the monitoring system 108 can monitor the status of a business object (e.g., whether the business object is being utilized or how the business object is implemented in a business process), and the status of at least one process agent (e.g., whether the process agent is being utilized or how and which business object the process agent links to the business processes under progress). The monitoring system 108 also can monitor changes in the configuration of a particular business process (e.g., whether a particular business object is a new business object, or whether a particular process agent has been activated). The monitoring system 108 can provide monitored information associated with real business processes to one or more users of the client system 102.

In some implementations, the main system 104 may be integrated with the client system 102 through the network 110, which can be configured to facilitate continuous or periodic data exchange between the main system 104 and the client system 102 using conventional networking protocols (e.g., TCP/IP, HTTP). The networking protocol interfaces may allow the client system 102 to connect directly to any application within the system 100, or to external applications via the network 110.

Information exchanged between the main system 104 and the client system 102 may include commands or requests to perform one or more particular processes or finctions of a process (or processes) such as processes to monitor, analyze or verify data consistency.

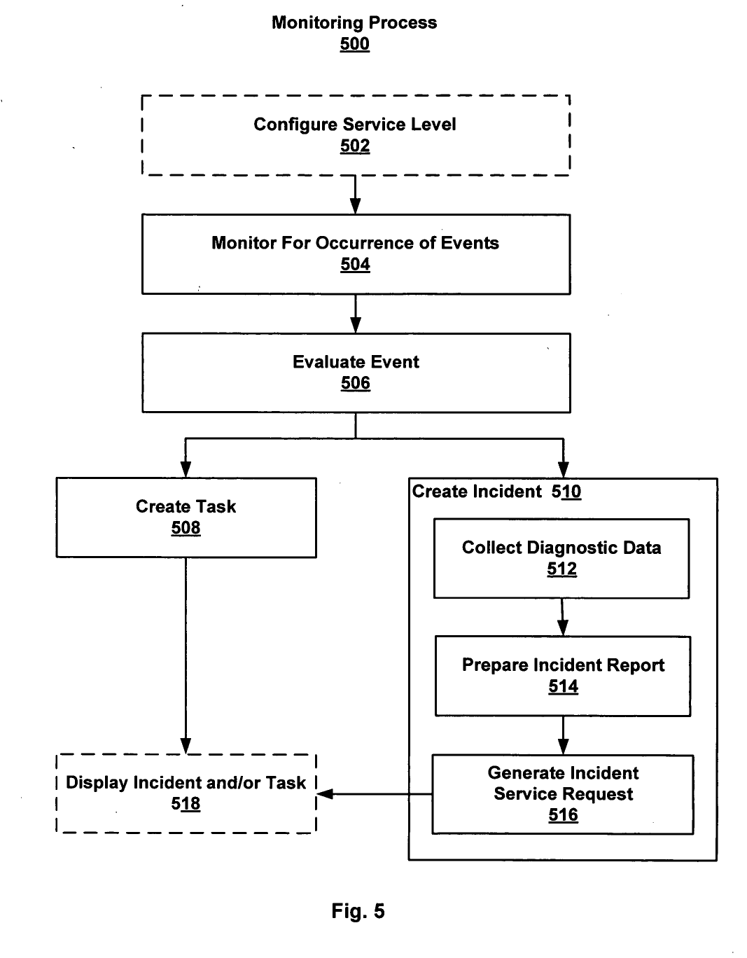

In some implementations, all information, tools and documents needed to perform a specific task between the main system 104 and the client system 102 are centrally and remotely available. Monitoring processes conducted for safe operations of the client system 102 may be automated and pre-configured, and the level of monitoring may be chosen based on a service level structure, as will be discussed with respect to FIG. 5.

In other implementations, by periodically or continuously monitoring the modeling system 106 simulating the client system 102, the main system 104 may learn new system settings and configurations adopted by the client system 102 during a scheduled update without user intervention.

Periodically, system information (e.g., status or configuration settings) associated with the client system 102 may be transmitted to the main system 104 through the network 110. In some implementations, the main system 104 may request system information from the client system 102 on a scheduled basis using, for example, a polling scheme. In other implementations, the client system 102 may transmit system information to the main system 104 continuously or periodically, or in response to one or more trigger events.

In some implementations, the modeling system 106 includes various embedded services, including, but not limited to, an integrated operations handbook, automated health checks, software maintenance management, and incident management. The integrated operations handbook may include automated task and incident handling and a central administration console for operational management. The automated health check service may provide users (e.g. IT administrators) with instant access to information and eliminate the need for manual monitoring. The incident management service may be integrated with the main system 104, and may provide end user support and automated context collection for resolving incidents, as will be discussed in greater detail later. The software maintenance management service may provide one-click update installation triggered by health checks or other data collection/monitoring services, and also provides proactive notification of updates available for download.

It should be apparent that the system 100 is exemplary and other configurations, arrangements and network topologies for system 100 are possible, including multiple clients 102 and/or multiple main systems 104.

### Business Process Overview

On the client system 102, one or more business processes may be running. A business process may be defined as a set of one or more operations, functions, procedures, or methods that accept one or more inputs to cause a particular outcome. For example, a sales business process for which the inputs may include identification of goods and/or services, a request for quote and a sales order, can have an outcome that is the generation of revenue based on the sales of goods and/or services. The operations(s) associated with the sales business process accepts the inputs to cause generation of revenue based on the sale. Example operations in the sales business process may include: accepting and processing a request for quote; accepting and processing a sales order; causing the delivery of goods or services in response to the sales order; and collecting payment for the delivery of the goods or services.

Furthermore, each operation may incorporate various sub-operations. For example, to deliver goods, a company may manufacture the goods, or otherwise obtain them; stock them in a warehouse; load them from the warehouse onto a truck; and deliver them to the customer.

Moreover, business processes can interact with other business processes to exchange information and collectively achieve an outcome.

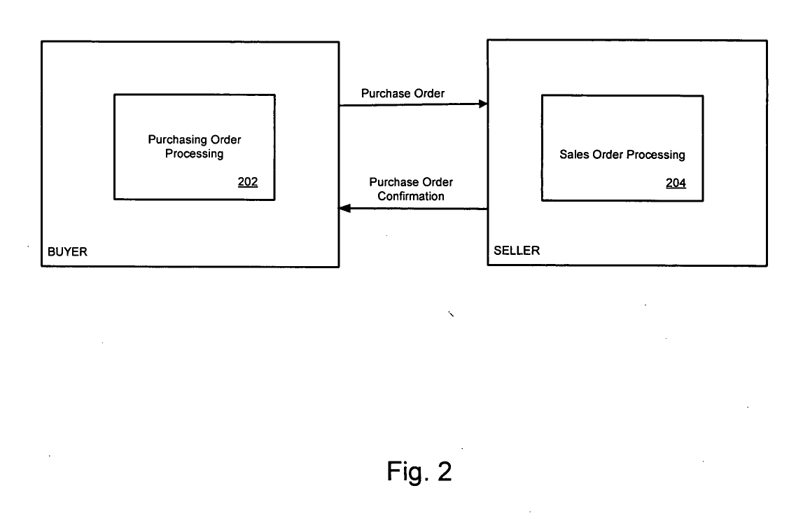

FIG. 2 illustrates an exemplary interaction between purchase order processing and sales order processing. Referring to FIG. 2, a buyer creates a purchase order through a purchase order processing system 202, and the purchase order is sent to a seller electronically. The seller receives the purchase order, and creates a corresponding sales order among other sales order processing applications in the sales order processing system 204. A purchase order confirmation is then sent back to the buyer to confirm the purchase order.

In this illustration, purchase order processing and sales order processing are process components that describe business processes. Each process component includes one or more business objects (e.g., purchase order processing includes a business object “purchase order” and a business object “purchase order confirmation,” and the sales order processing includes a business object “sales order”).

### Modeling System Architecture

A business process and interactions between business processes can be described by a model. In some implementations, a model is a representation of a software system. For example, the modeling system 106 of FIG. 1 can be used to create, modify and examine a model.

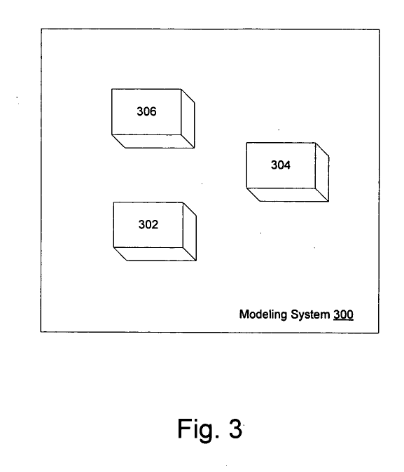

FIG. 3 illustrates exemplary components defined in a modeling system 300. The modeling system 300 generally includes a modeling module 302, an interactive graphical user interface (GUI) module 304, and design parameters 306 associated with a given model (or business process). The modeling module 302 may store one or more models and associated information. By way of illustration and without limitation, the modeling module 302 can incorporate one or more files, databases, services, combinations thereof, or other suitable means for providing persistent storage of information associated with the model(s). In some implementations, settings and configurations associated with a business process running on a client system may be available through the modeling module 302.

The GUI module 304 allows a user to create, inspect and modify a model. The GUI module 304 can present a model in different views offering differing levels of detail. This allows a user to focus on information that is appropriate to their role or task at hand. The design parameters module 306 coupled to the GUI module 304 may provide one or more processor components as tools for modifying and manipulating a model or models, as will be discussed in greater detail below.

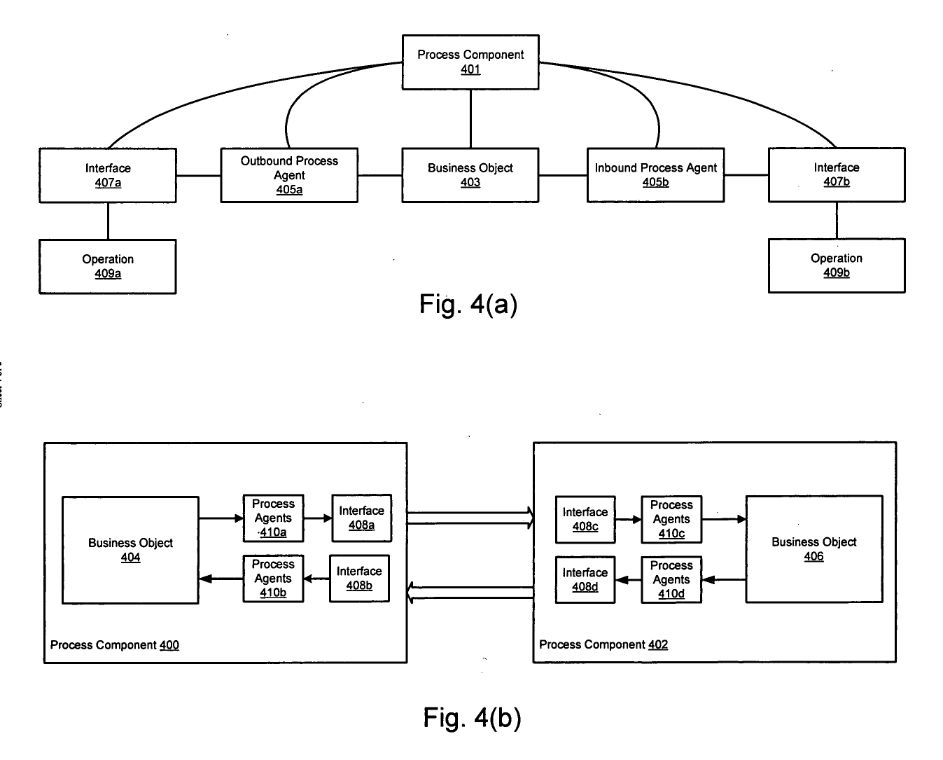

FIG. 4(a) shows exemplary structure of a process component. Referring to FIG. 4(a), a process component (401) generally includes a business object (403), inbound and outbound process agents (405a, 405b), inbound and outbound interfaces (407a, 407b) and corresponding operations (409a, 409b). FIG. 4(b) shows interaction between two process components.

Referring to FIG. 4(b), process components (400, 402) generally describe business processes (e.g., purchase order processing). The process components (400, 402) may include one or more business objects (404, 406) (e.g., purchase order object, purchase order confirmation object, etc.). In some implementations, one or more business objects (404, 406) may be uniquely assigned to one or more process components (400, 402).

A business object may be logically encapsulated by a process component and serves to describe model data or information used by a business process modeled by the process component. A business object may be an instance of a business object class definition. A business object class definition specifies one or more object attributes and optionally, values for the attributes. An attribute may be a member of a business object that represents data or information and has an associated type. The type describes the nature of data or information associated with a given attribute. By way of illustration and without limitation, a type can be a simple type, such as an integer, a floating point number, a Boolean value, an enumeration, or a character. A type can also be complex, such as (without limitation) an array, list, graph, set, or a combination of simple and/or complex types.

Each process component (400, 402) may be associated with one or more interfaces (408a, 408b, 408c, 408d), each of which describes one or more operations supported by the associated process component (400, 402). An operation can be a description of a finction associated with one or more messages.

Messages may be sent between business objects or process components via process agents. Process agents are mediators between a business logic of a business object and associated process component. Each process agent may be assigned to one business object and triggers one business process. Based on status, data and process history of a business object, associated process agents may communicate with other process components by sending business documents representing business content of a message. Process agents may handle business document reception, and map the content described in the received business document to one or more business objects during inbound processing.

In some implementations, process agents run in the same database transaction so that business objects and messages sent through the process agents are consistently stored at a centralized location. In some implementations, process agents can be categorized into outbound process agents and inbound process agents. At the sending side, a business object can have one or more outbound process agents. Each outbound process agent may be assigned to one business object and initiates one subsequent business process. At the receiving side, each inbound process agent may be assigned to one or more business objects so that an inbound message may result in updates on corresponding business objects when processed by an inbound process agent. Each business object also may be updated by different inbound process agents.

Output process agents (410a, 410d) may generally describe events leading to sending a message. Output process agents (410a, 410d) may invoke an operation through an associated interface (408a, 408d) to send a message to corresponding inbound process agents (410b, 410c). For example, outbound process agent 410aof process component 400 may invoke an operation through interfaces 408a and 408c to send a message to the inbound process agent 410c of process component 402. The message may be directed to a specific operation in interface 408c which the inbound process agent 410c is to handle.

Inbound process agents (410b, 410c) can access and modify or interact with an associated business object (400, 402) in response to receiving a message. Outbound process agents (410a, 410d) can send messages in response to a modified business object or interaction with another business object. For example, the inbound process agent 410cmay modify business object 402, thus triggering outbound process agent 410d to send a message to the inbound process agent 410b of process component 400. In some implementations, a process agent is not required to use a business object.

### Monitoring System Overview

Referring again to FIG. 1, the monitoring system 108 graphically monitors business process performance in real-time, and proactively alerts service provider of the main system to potential issues. The core architecture of monitoring system 108 may include a series of programming instructions for obtaining configuration data or transactional messages from one or more process agents of the modeling system 106, analyzing messages sent and received by process agents for errors, logging detected data inconsistencies, and generating error report.

In some implementations, monitoring system 108 monitors the execution of individual business process running on the modeling system 106, analyzes the overall behavior of a set of business processes, and verifies successful performance of the business processes. Any information retrieved from the business object or process agents may be used to create graphical reports, which may contain analytical information, statistical information, error tracking and/or impact of error within a business process.

In some implementations, the monitoring system may be implemented as a Java applet which enables web browsers to execute it. Without user intervention, the automated monitoring system can monitor events and messages associated with the business objects or process components running on the client system 102. For example, the monitoring system can be adapted to monitor events associated with orders, package assembly, shipping and payments. That is, the monitoring system 108 can monitor different business objects in different parts of a process component.

In some implementations, the monitoring system 108 can be trained to analyze a specific business object or process component, or look for particular messages or conditions among the business objects, process components or process agents that would indicate a problem. Such problems may include, but are not limited to, changes to existing orders (e.g., canceled orders, large orders against inventory), bottlenecks in the package assembly, delays in shipments and cash flow problems because of late payments.

In some implementations, the monitoring system 108 provides a framework for creating, managing and reporting on an individual business process. Monitoring system 108 can also provide archiving or logging of the business objects or process agents running on the client system 102. Monitoring system 108 can provide visualization software that creates and reports information to an operator (e.g., service provider of the main system 104). Such information can include, but is not limited to, analytical tools, statistical information, data tacking, cost analysis, etc.

In some implementations, monitoring system 108 may generate one or more reports in response to one or more events detected or retrieved from a process component, business object or process agents. The report may indicate inconsistent records associated with a particular process component or business object so that corrective measure can be taken. In some implementations, incorrect records may be marked in the report to indicate a specific event attributable to a particular business process or process component. The report may be in numeric or graphical format, using tools such as charts, ranking or statistical analysis to describe the event detected in the modeling system 106.

### Monitoring Process

FIG. 5 is a flow diagram of an exemplary monitoring process 500. The monitoring process 500 can continually or periodically monitor modifications to a business object, and create incidents and/or administration tasks if a critical or conflicting situation is detected. Such critical or conflicting situation may include, but is not limited to, software error or an inconsistent configuration of a business object, and inconsistency of a business process, for example, when one business object has configured its data in a persistent layer (e.g., database or file system) and another business object has not. At step 502, an operator of a client system (e.g., an IT administrator) can configure the service level for the client system using, for example, a service level configuration user interface. For example, the operator can define the schedule that the monitoring process 500 is to perform (e.g., constantly or periodically, such as every hour or daily).

In some implementations, step 502 may be performed during design time (i.e., once the operator configures the service level, the service level no longer needs reconfiguration to initiate the monitoring process 500 unless the schedule or other service level information is subsequently modified). In these implementations, during run-time of the monitoring process 500, step 502 may not be performed as the service level may have already been set by the operator during design time.

In some implementations, the monitoring process 500 begins in accordance with a pre-defined schedule (e.g., hourly or daily schedule set by the operator of a client system during service level configuration 502). In other implementations, the monitoring process 500 begins when initiated by the operator. Once monitoring settings are specified and the monitoring process 500 is initiated, at step 504, process components and/or business objects (i.e., occurrence of events) running on the modeling system 106 are monitored based on the schedule defined in the settings.

Monitoring system 108 may collect and diagnose data and messages transmitted and received among business objects and/or process agents that may adversely affect the running business processes. Diagnostic data and messages may be retrieved from the client system (102). Through the modeling module (302), monitoring system 108 can retrieve information associated with how messages and diagnostic data are linked to a particular business process, and present the results of the retrieval to the user of a client system as real-time business process monitoring.

In some implementations, the monitoring system 108 automatically monitors events in operational business processes, detects specific business conditions and changes in business processes, alerts upon detection of changes made to a business object, and alerts the service provider to draw attention to a specific business object or interface component.

As discussed above, the modeling system 106 also may be monitored for the occurrence of any events. In some implementations, an event may be defined as, for example, changes made to a business object. In other implementations, each business object may have a time constraint associated for its execution. Should the constraint be exceeded, the monitoring process 500 may classify the constraint as an event. The event is then reported and pushed to be evaluated (e.g., by an evaluation engine) at step 506.

At step 506, the monitoring process 500 may determine whether the reported event (e.g., modified business object) should be classified as an incident or an administrative task. In some implementations, additional information about the event may be desired and can be retrieved from the process agents (or from a repository) associated with the reported business object to determine whether the event should be classified as an incident or an administrative task. Based on the retrieved information, the tasks which are necessary to analyze and resolve the event may be selected from, for example, a task catalog (data storage) of an integrated electronic operations handbook, and processed to determine whether to classify the reported event as an incident or an administrative task. If the tasks necessary to analyze the event are located, the event is classified as an administrative task; otherwise, the event is classified as an incident.

In some implementations, classifying the generated event as an incident or an administrative task can be based on predefined criteria, as provided by the task catalog of the integrated operations handbook. The task catalog may include predefined task events and other information such as task schedules, task responsibilities, and service level agreement data. In some implementations, the task catalog may define, in advance, the responsible person for processing the task event. Thus, in some implementations, evaluating whether a reported event should be classified as an incident or task can be accomplished by searching the operations handbook to determine if the reported event is listed in the operations handbook. If the reported event is not listed, then the reported event can be classified as an incident, and a service request containing all relevant context information associated with the event may be created automatically. If the reported event is listed, then the reported event can be classified as an administrative task.

If the generated event has been evaluated and determined to correspond to an administrative task (e.g., a configuration parameter of a business object needs to be changed according to a predefined schedule), then at step 508, an administrative task is created and associated context data is provided with the administrative task. Optionally, an administrative task can be time-based triggered (e.g., periodic administrative task or a combination of time-based triggered and event-based triggered). At step 518, the created administrative task may be optionally displayed via user interfaces for use during task management.

Alternatively, if the generated event has been evaluated and determined to correspond to an incident, at step 510, an incident is created and optionally displayed via user interfaces. As discussed above, when creating an incident 510, the context (or diagnostic) data associated with the incident may be automatically collected. The context or diagnostic data may include, but is not limited to, technical and application information that is usually required to resolve the incident. The context data may further include relevant business object or process components information retrieved from one of architectural layers, such as a user interface layer, an enterprise service layer, a business object layer and a system layer. Because the context data is automatically collected, at or near the time of the event, which caused the creation of the incident, the state of the business object causing the incident can be preserved. This is an improvement over conventional monitoring systems in which an operator may attempt to resolve the incident after the associated context information may have already been deleted.

Next, at step 514, an incident report is generated, which provides an explanation of why and how the incident was triggered with the collected context data. Thereafter, at step 516, an incident service request is generated, typically by a service desk, such as a Customer Relationship Management (CRM) system residing on an application platform within the client system 102 or main system 104. In such implementations, the service provider of the main system receives the incident report, stores the report, and generates a corresponding service request. The incident service request may then be optionally displayed in a user interface, so that an operator or other end user can be visually notified of the incident service request and track the status of the incident service request.

The invention and all of the fuctional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component (e.g., a data server), a middleware component (e.g., an application server), or a front-end component (e.g., a client computer having a graphical user interface or a Web browser through which a user can interact with an implementation of the invention), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments, but other embodiments can be implemented and are within the scope of the following claims. For example, the operations of the invention can be performed in a different order and still achieve desirable results. As one example, the process depicted in FIG. 5 does not require every step shown, or the particular order illustrated, to achieve desirable results (e.g., steps 502 and 504 can be separate from the monitoring process 500). In certain implementations, multitasking and parallel processing may be preferable. Other embodiments are within the scope of the following claims.

What is claimed is:

1. A method comprising:
hosting a business process associated with a business application, the business process including a business object and one or more process agents adapted to execute the business process;
modeling the business process using a modeled business process, the business application configured to perform the modeled business process; and
monitoring configuration data of the modeled business process and that of the business process associated with the business application for any inconsistency therebetween.

2. A method comprising:
obtaining configuration data associated with an actual business process on a predetermined schedule without user intervention;
monitoring a modeled business process simulating the actual business process, the modeled business process having one or more process agents associated with a business object;
determining whether the configuration data has been modified based on the modeled business process; and
detecting a potential issue associated with the modified configuration data.

3. The method of claim 2, where determining whether the configuration data has been modified includes:
monitoring data or messages transmitted and received between process agents, or between the business object and one or more of the process agents; and
detecting data or messages indicative of inconsistency between the modeled business process and the actual business process based on the monitored data or messages.

4. The method of claim 3, where detecting a potential issue includes generating analysis information in response to the detected data or messages.

5. The method of claim 2, where monitoring the modeled business process includes monitoring errors or warnings created during processing of the business object.

6. The method of claim 2, where monitoring the modeled business process includes monitoring status of the business object or status of at least one process agent.

7. The method of claim 2, where monitoring the modeled business process includes periodically or continuously monitoring the modeled business process to detect a new configuration adopted by the actual business process.

8. The method of claim 2, where monitoring the modeled business process includes collecting information exchanged between two or more process agents, or between the business object and at least one of the process agents.

9. The method of claim 2, where monitoring the modeled business process includes retrieving information associated with how diagnostic messages or data exchanged between two or more process agents, or between the business object and at least one of the process agents are linked to the modeled business process.

10. The method of claim 2, where monitoring the modeled business process includes:
monitoring events in the modeled business process;
detecting predetermined business conditions and changes in the modeled business process; and
alerting a service provider to draw attention to the business object or the actual business process upon detection of the predetermined business conditions or changes.

11. The method of claim 2, further comprising presenting the detected potential issue associated with the modified configuration data to a user in real time.

12. A method comprising:
obtaining configuration data associated with an actual business process;
monitoring a modeled business process simulating the actual business process on a predetermined schedule without user intervention, the modeled business process having one or more process agents associated with a business object;
collecting diagnostic data exchanged between process agents or between at least one of process agents and the business object to detect an event associated with the actual business process; and
evaluating whether the detected event is critical.

13. The method of claim 12, where evaluating whether the detected event is critical includes classifying the event as either an incident or an administrative task.

14. The method of claim 13, where classifying the event includes:
retrieving additional information about the event from the process agents;
searching a task catalog including predefined tasks to locate a task for solving the event;
classifying the event as the administrative task if the task is located in the task catalog; and
classifying the event as the incident if the task is not listed in the task catalog.

15. The method of claim 14, further comprising automatically generating a service request containing the diagnostic data associated with the detected event if the detected event is classified as an incident.

16. The method of claim 14, further comprising:
implementing the located task for solving the event if the detected event is classified as an administrative task; and
verifying successful implementation of the task by tracking performance of the actual business process.

17. The method of claim 12, further comprising displaying the collected diagnostic data in real time to a user.

18. The method of claim 12, where monitoring a modeled business process includes monitoring changes to configuration of the actual business process.

19. A method comprising:
hosting an actual business process on a client;
modeling the actual business process running on the client;
monitoring the modeled business process to detect an event indicating a change in an operational parameter of the actual business process or the modeled business process without user intervention; and
automatically routing the event to a service provider if a change is made to the operational parameter of the actual business process or the modeled business process.

20. The method of claim 19, further comprising:
evaluating whether the routed event is critical;
classifying the routed event as either an incident or an administrative task;
searching a task catalog including predefined tasks to locate a task for solving the event;
classifying the routed event as the administrative task if a task for solving the routed event is located in a task catalog containing predefined tasks; and
classifying the routed event as the incident if the task is not listed in the task catalog.
